(19) United States
(12) Patent Application Publication
(10) Pub. No.: US 2020/0144847 A1
(43) Pub. Date: May 7, 2020

(54) WIRELESS CHARGING CONVERTING APPARATUS AND PROTECTIVE SHELL HAVING SAME

(71) Applicant: NEWVASTEK CO., LTD., TAIPEI CITY (TW)

(72) Inventors: Ming-Liang Fang, TAIPEI CITY (TW); Sheng-Kuan Chen, TAIPEI CITY (TW); Chih-Hao Chuang, TAIPEI CITY (TW)

(73) Assignee: NEWVASTEK CO., LTD., TAIPEI CITY (TW)

(21) Appl. No.: 16/675,577

(22) Filed: Nov. 6, 2019

(30) Foreign Application Priority Data
Nov. 7, 2018 (TW) 107139577

(51) Int. Cl. H02J 7/02; H02J 50/10; H01F 38/14; H02J 7/00; H02J 50/70

(52) U.S. Cl. CPC H02J 7/025; H02J 50/10; H02J 50/70; H02J 7/0044; H01F 38/14

(57) ABSTRACT

A wireless charging converting apparatus includes a circuit board, a receive coil, a primary circuit, a transmit coil, a high-frequency magnetic isolation sheet, and a low-frequency magnetic isolation sheet. The receive coil is located on the circuit board to receive a high-frequency magnetic signal and convert the high-frequency magnetic signal into a first alternating-current signal. The primary circuit is located on the circuit board to receive the first alternating-current signal and convert the first alternating-current signal into a second alternating-current signal. The transmit coil is to convert the second alternating-current signal into a low-frequency magnetic signal. The low-frequency magnetic isolation sheet is located between the transmit coil and the circuit board. The high-frequency magnetic isolation sheet is located between the low-frequency magnetic isolation sheet and the receive coil. In addition, a protective shell having a wireless charging converting apparatus is also provided.

### CROSS-REFERENCE TO RELATED APPLICATION

This non-provisional application claims priority under 35 U.S.C. § 119(a) to Patent Application No. 107139577 filed in Taiwan, R.O.C. on Nov. 7, 2018, the entire contents of which are hereby incorporated by reference.

### BACKGROUND

### Technical Field

The present invention relates to a wireless charging converting technology, and in particular, to a wireless charging converting apparatus and a protective shell having same.

### Related Art

In recent years, as smartphones rise, related technologies prosperously develop. There are also breakthroughs in a wireless charging technology in many aspects. In addition to portable electronic devices such as mobile phones and notebook computers, wireless charging solutions are also continuously provided to smart appliances and vehicles. Current wireless charging standards mainly include the Qi wireless charging standard released by the Wireless Power Consortium (WPC) and the AirFuel wireless charging standard released by the AirFuel Alliance, a merger between the Alliance for Wireless Power (A4WP) and the Power Matters Alliance (PMA).

The Qi wireless charging standard mainly uses an electromagnetic induction technology, and the AirFuel wireless charging standard is based on a magnetic induction and magnetic resonance technology. The electromagnetic induction can implement wireless charging in a relatively long distance but the charging efficiency is relatively low, while the magnetic resonance wireless charging technology, although requiring a relatively short distance, can reach relatively high charging efficiency.

### SUMMARY

If a charging manner used by a wireless charging station is the AirFuel wireless charging standard, a mobile phone of a user needs a wireless charging chip that matches the AirFuel wireless charging standard, so that charging can be performed. However, wireless charging chips of most commercially-available smartphones use the Qi wireless charging standard, and therefore cannot match the AirFuel wireless charging standard provided by the charging station.

In view of this, an embodiment of the present invention provides a wireless charging converting apparatus. The wireless charging converting apparatus includes a circuit board, a receive coil, a primary circuit, a transmit coil, a low-frequency magnetic isolation sheet, and a high-frequency magnetic isolation sheet. The receive coil is located on the circuit board and is adapted to receive a high-frequency magnetic signal and convert the high-frequency magnetic signal into a first alternating-current signal. The primary circuit is located on the circuit board and is adapted to receive the first alternating-current signal and convert the first alternating-current signal into a second alternating-current signal. The transmit coil is adapted to convert the second alternating-current signal into a low-frequency magnetic signal. The low-frequency magnetic isolation sheet is located between the transmit coil and the circuit board. The high-frequency magnetic isolation sheet is located between the low-frequency magnetic isolation sheet and the receive coil.

In addition, another embodiment of the present invention provides a protective shell. The protective shell includes a housing and the foregoing wireless charging converting apparatus. The housing has an inner surface and an outer surface. The inner surface includes an accommodation slot and is adapted to accommodate a portable electronic device. The wireless charging converting apparatus is disposed in the housing. Moreover, the transmit coil of the wireless charging converting apparatus faces the housing and is adapted to correspond to a wireless charging module of the portable electronic device.

In one or more embodiments, the circuit board has a circuit area, the primary circuit is located in a circuit area, and the circuit area is surrounded by the receive coil and the high-frequency magnetic isolation sheet.

In one or more embodiments, the primary circuit includes a rectifier module disposed on a side of the circuit board and a conversion module disposed on another side of the circuit board. The rectifier module is electrically connected to the receive coil and is adapted to receive the first alternating-current signal and convert the first alternating-current signal into a direct-current signal. The conversion module is electrically connected to the transmit coil and is adapted to convert the direct-current signal into the second alternating-current signal.

In one or more embodiments, a surface of the high-frequency magnetic isolation sheet is essentially flush with a surface of the primary circuit.

In one or more embodiments, the low-frequency magnetic isolation sheet is made of nano-crystal.

In one or more embodiments, the high-frequency magnetic isolation sheet is made of ferrite.

In one or more embodiments, a magnetic permeability of the high-frequency magnetic isolation sheet is between 100 H/m and 700 H/m, and a magnetic permeability of the low-frequency magnetic isolation sheet is between 700 H/m and 1100 H/m.

In one or more embodiments, a profile of the high-frequency magnetic isolation sheet is inverted U-shaped, the high-frequency magnetic isolation sheet has a groove, and the primary circuit is located in the groove.

In one or more embodiments, the high-frequency magnetic isolation sheet is shielded between the primary circuit and the transmit coil.

In conclusion, in the one or more embodiments of the present invention, the wireless charging converting apparatus can convert a magnetic signal that satisfies a wireless charging standard into a magnetic signal that satisfies another wireless charging standard. In addition, the high-frequency magnetic isolation sheet and the low-frequency magnetic isolation sheet can effectively prevent the magnetic signal from interfering with the primary circuit or the coil. Furthermore, in the one or more embodiments of the present invention, a user can put the portable electronic device into the protective shell having the wireless charging converting apparatus, so that a magnetic signal that is sent by a wireless charging station can be converted, by using the wireless charging converting apparatus of the protective shell, into another magnetic signal that matches the wireless charging module of the portable electronic device, thereby implementing wireless charging.

### BRIEF DESCRIPTION OF THE DRAWINGS

The present invention will become more fully understood from the detailed description given herein below for illustration only, and thus are not limitative of the present invention, and wherein:

FIG. 1 is a schematic sectional view of a first embodiment of a wireless charging converting apparatus according to the present invention;

FIG. 2 is an exploded view of a first embodiment of wireless charging converting apparatus according to the present invention;

FIG. 3 is a block diagram of an example circuit of a wireless charging converting apparatus according to the present invention;

FIG. 4 is a block diagram of another exemplary circuit of a wireless charging converting apparatus according to the present invention;

FIG. 5 is a schematic sectional view of a second embodiment of a wireless charging converting apparatus according to the present invention;

FIG. 6 is an exploded view of a second embodiment of a wireless charging converting apparatus according to the present invention;

FIG. 7 is a schematic sectional view of a third embodiment of a wireless charging converting apparatus according to the present invention;

FIG. 8 is an exploded view of a third embodiment of a wireless charging converting apparatus according to the present invention; and

FIG. 9 is a schematic diagram of a use status of an exemplary embodiment of a protective shell having a wireless charging converting apparatus according to the present invention.

### DETAILED DESCRIPTION

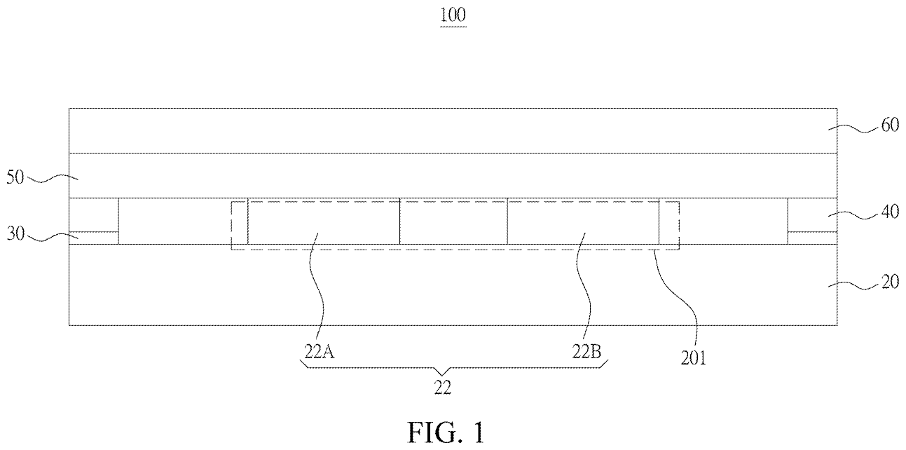

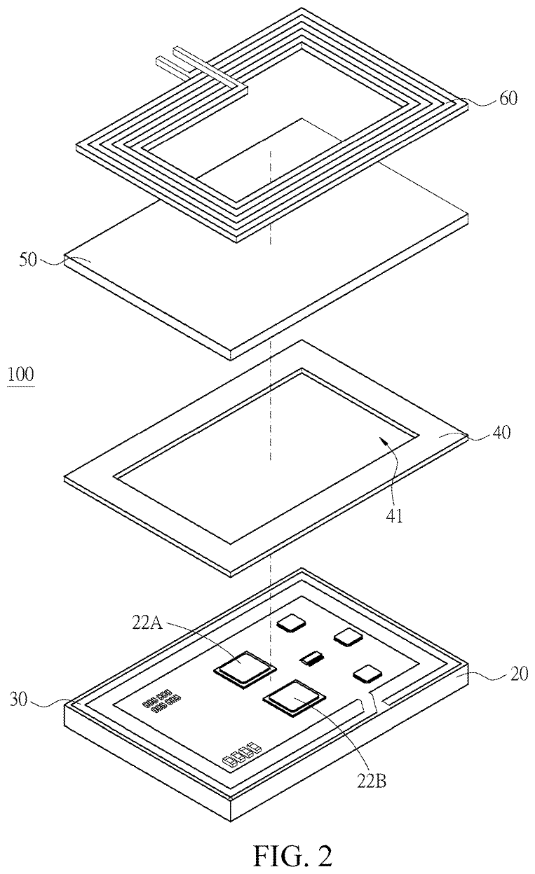

Referring to FIG. 1 and FIG. 2, FIG. 1 and FIG. 2 are respectively a schematic sectional view and an exploded view of a first embodiment of a wireless charging converting apparatus 100 according to the present invention. As shown in FIG. 1 and FIG. 2, the wireless charging converting apparatus 100 includes a circuit board 20, a receive coil 30, a primary circuit 22, a transmit coil 60, a low-frequency magnetic isolation sheet 50, and a high-frequency magnetic isolation sheet 40.

The wireless charging converting apparatus 100 may be adapted to perform conversion between magnetic signals that satisfy different wireless charging standards. For example, when wireless charging is to be performed, by using a wireless charging station that matches an AirFuel wireless charging standard (hereinafter briefly referred to as AirFuel standard) of a high-frequency magnetic signal, on an electronic device that matches a Qi wireless charging standard (hereinafter briefly referred to as Qi standard) of a low-frequency magnetic signal, the high-frequency magnetic signal may be converted into the low-frequency magnetic signal by using the wireless charging converting apparatus 100. Herein, the electronic device is, for example but not limited to, a mobile phone, a notebook computer, a tablet computer, and a digital camera. In other words, in this embodiment, the receive coil 30 satisfies the AirFuel standard and therefore can receive a magnetic signal from a wireless charging station that uses the AirFuel standard; and the transmit coil 60 satisfies the Qi standard and therefore can transmit the magnetic signal to an electronic device that uses the Qi standard.

Specifically, the wireless charging converting apparatus 100 can be disposed in a peripheral element of the electronic device, to implement the foregoing conversion between the different magnetic signals. In an embodiment, the wireless charging converting apparatus 100 may be disposed in a protective shell of the electronic device, but the present invention is not limited thereto.

Referring to FIG. 1 and FIG. 2, the circuit board 20 may be a printed circuit board, and is, for example but not limited to, a stencil printed circuit board. Moreover, the circuit board 20 can be a glass substrate in addition to a plastic substrate.

The receive coil 30 is located on the circuit board 20. The receive coil 30 is adapted to generate the foregoing first alternating-current signal after receiving the high-frequency magnetic signal. In an embodiment, the receive coil 30 may be directly printed on the circuit board 20, and may further reduce an overall thickness of the wireless charging converting apparatus 100, but this is not limited thereto. In some embodiments, the receive coil 30 may alternatively be a coil element of a common specification or a special specification that is additionally mounted on the circuit board 20. In this embodiment, the high-frequency magnetic signal is a magnetic signal whose signal frequency is between 1 MHz and 1000 MHz, but this is not limited thereto. In some embodiments, the high-frequency magnetic signal is a magnetic signal whose signal frequency is equal to 6.78 MHz.

The primary circuit 22 is located on the circuit board 20 and is adapted to receive the first alternating-current signal and convert the first alternating-current signal into a second alternating-current signal. A frequency of the first alternating-current signal is different from a frequency of the second alternating-current signal, and therefore magnetic signal frequencies that correspond to the first alternating-current signal and the second alternating-current signal are also different.

The transmit coil 60 is adapted to receive the second alternating-current signal and generate a low-frequency magnetic signal. In this embodiment, similarly, the low-frequency magnetic signal is a magnetic signal whose signal frequency is between 10 KHz and 300 KHz, but this is not limited thereto. In some embodiments, the low-frequency magnetic signal is a magnetic signal whose signal frequency is equal to 110 KHz to 205 KHz.

The low-frequency magnetic isolation sheet 50 is located between the transmit coil 60 and the circuit board 20. The low-frequency magnetic isolation sheet 50 is adapted to block the low-frequency magnetic signal. Specifically, the low-frequency magnetic isolation sheet 50 is adapted to block the low-frequency magnetic signal generated by the transmit coil 60 (for example, a magnetic signal generated by a wireless charging transmit coil that satisfies the Qi standard), thereby preventing the low-frequency magnetic signal from interfering with the components of the primary circuit 22 and the receive coil 30.

In an embodiment, a magnetic permeability of the low-frequency magnetic isolation sheet 50 is between 700 H/m and 1100 H/m, and may be, for example but is not limited to 730 H/m. In an embodiment, the low-frequency magnetic isolation sheet 50 may be made of nano-crystal, and may also be made of ferrite or non-crystal materials, but this is not limited thereto. In addition, in an embodiment, the low-frequency magnetic isolation sheet 50 may be a four-layer nano-crystal structure and has a thickness of about 0.08 micron, so that the thickness of the wireless charging converting apparatus 100 can be effectively reduced.

Then referring to FIG. 1 and FIG. 2, the high-frequency magnetic isolation sheet 40 is located between the low-frequency magnetic isolation sheet 50 and the receive coil 30. The high-frequency magnetic isolation sheet 40 is adapted to block the high-frequency magnetic signal. Specifically, the high-frequency magnetic isolation sheet 40 is adapted to block a high-frequency magnetic signal generated by a wireless charging station (for example, a magnetic signal generated by a coil of a wireless charging station that satisfies the AirFuel standard), thereby preventing the high-frequency magnetic signal from interfering with the components of the primary circuit 22 and the transmit coil 60, so that a coupling capability of the coil can be improved.

In an embodiment, a magnetic permeability of the high-frequency magnetic isolation sheet 40 is between 100 H/m and 700 H/m, and may be, for example but is not limited to 240 H/m. In an embodiment, the high-frequency magnetic isolation sheet 40 may be made of ferrite. In addition, in an embodiment, the high-frequency magnetic isolation sheet 40 has a thickness of about 200 microns. In addition, in this embodiment, a surface of the high-frequency magnetic isolation sheet 40 is essentially flush with a surface of the primary circuit 22 indicates that the surface of the high-frequency magnetic isolation sheet 40 is essentially flush with the surface of the primary circuit 22 is that the surface of the high-frequency magnetic isolation sheet 40 is at a same level with the surface of the primary circuit 22; or that the surface of the high-frequency magnetic isolation sheet 40 is flush with the primary circuit 22 after viscose is added to the high-frequency magnetic isolation sheet 40. In this way, the wireless charging converting apparatus 100 can have a relatively good mechanical strength.

In this embodiment, the receive coil 30 satisfies the AirFuel standard, and the transmit coil 60 satisfies the Qi standard. Therefore, a magnetic signal that satisfies the AirFuel standard and that is sent by the wireless charging station can be converted by the wireless charging converting apparatus 100 into a magnetic signal that satisfies the Qi standard, so that a portable electronic device that has a wireless charging chip that uses the Qi standard can be charged. In addition, the high-frequency magnetic isolation sheet 40 and the low-frequency magnetic isolation sheet 50 can effectively prevent the magnetic signal from interfering with the primary circuit 22 or the coil.

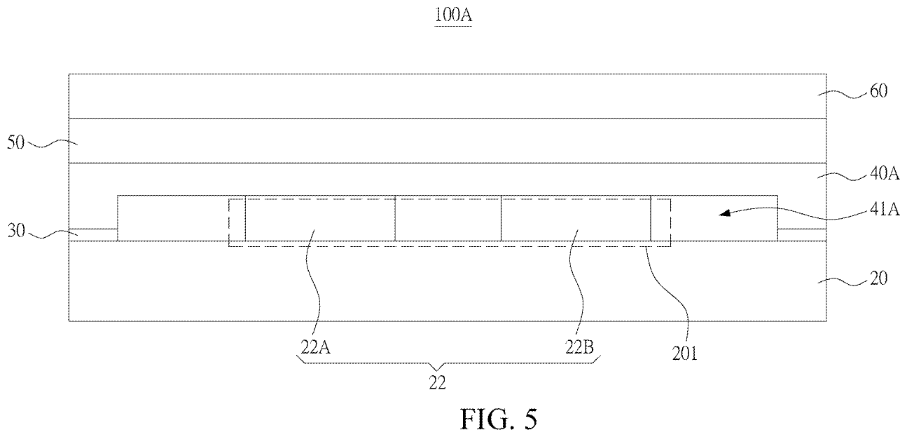

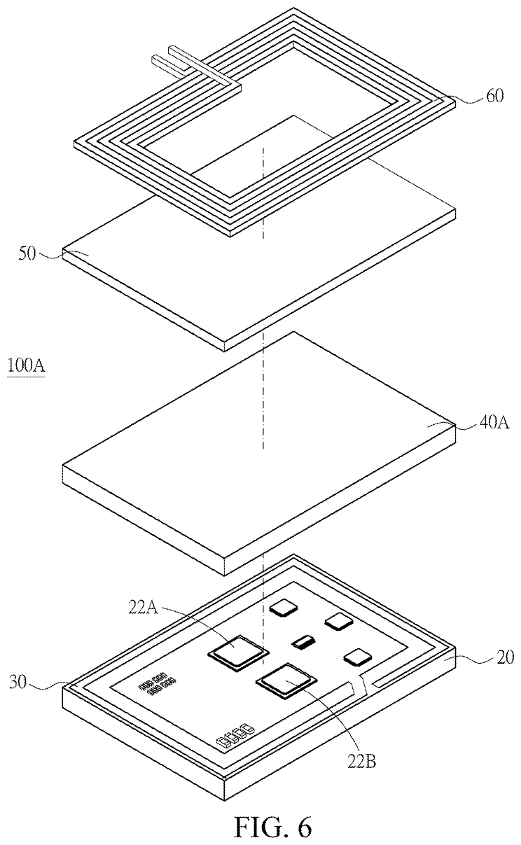

As shown in FIG. 1 and FIG. 2, in one or more embodiments, the high-frequency magnetic isolation sheet 40 is not shielded between the primary circuit 22 and the transmit coil 60. That is, the circuit board 20 has a circuit area 20a, the primary circuit 22 is located in the circuit area 20a, and the circuit area 20a is surrounded by the receive coil 30 and the high-frequency magnetic isolation sheet 40. In still other words, the high-frequency magnetic isolation sheet 40 has an opening 41, the primary circuit 22 is located in the opening 41, and the receive coil 30 is not exposed from the opening 41, but the present invention is not limited thereto. Referring to FIG. 5 and FIG. 6, FIG. 5 and FIG. 6 are respectively a schematic sectional view and an exploded view of a second embodiment of a wireless charging converting apparatus 100A according to the present invention. In this embodiment, a high-frequency magnetic isolation sheet 40A is shielded between the primary circuit 22 and the transmit coil 60. In addition, as shown in FIG. 5, a sectional profile of the high-frequency magnetic isolation sheet 40A is inverted U-shaped and has a groove 41A, and the primary circuit 22 is located in the groove 41A. In this embodiment, the groove 41A of the high-frequency magnetic isolation sheet 40A is not hollowed-out, thereby providing a relatively good mechanical strength and increasing the durability of the apparatus.

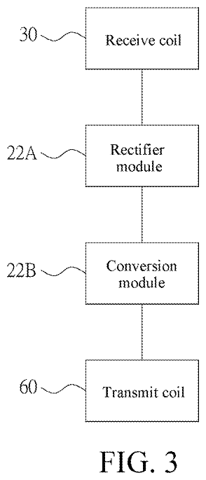

FIG. 3 is a block diagram of an example circuit of a wireless charging converting apparatus 100 according to the present invention. Referring to FIG. 1 to FIG. 3, in this embodiment, the primary circuit 22 includes a rectifier module 22A and a conversion module 22B. The rectifier module 22A is disposed on a side of the circuit board 20 and faces the low-frequency magnetic isolation sheet 50, and the conversion module 22B is disposed on another side of the circuit board 20 and also faces the low-frequency magnetic isolation sheet 50. The rectifier module 22A may be, for example, a rectifier, and is adapted to receive the first alternating-current signal and then convert the first alternating-current signal into a direct-current signal. The conversion module 22B may be, for example, a full-bridge inverter or a half-bridge inverter, and is adapted to receive the direct-current signal and then convert the direct-current signal into the second alternating-current signal.

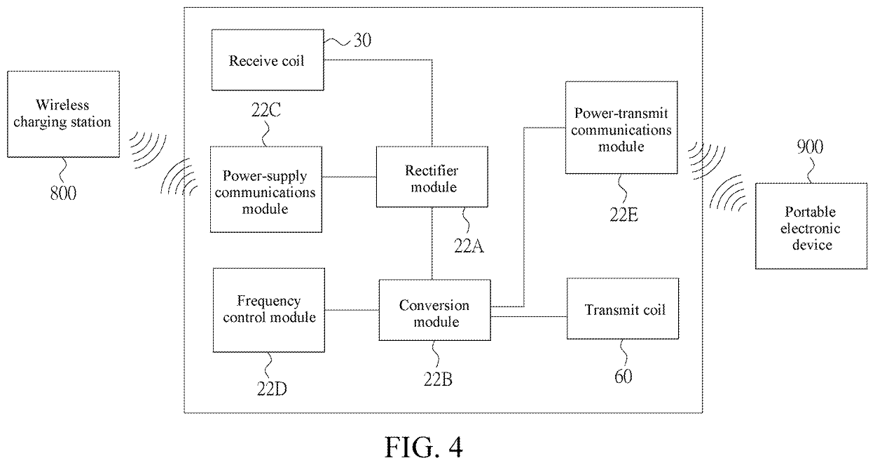

FIG. 4 is a block diagram of another example circuit of a wireless charging converting apparatus 100 according to the present invention. Referring to FIG. 1, FIG. 2, and FIG. 4, in this embodiment, the primary circuit 22 further includes a power-supply communications module 22C, a frequency control module 22D, and a power-transmit communications module 22E.

The power-supply communications module 22C is signally connected to the rectifier module 22A, to be adapted to perform handshaking with a wireless charging station 800, and the wireless charging station 800 generates a magnetic signal continuously (that is, the high-frequency magnetic signal) after performing the handshaking with the power-supply communications module 22C, and the wireless charging converting apparatus 100 performs the foregoing conversion operation on the magnetic signal again. In an embodiment, the power-supply communications module 22C may include a Bluetooth chip, so that the wireless charging converting apparatus 100 can perform handshaking with the wireless charging station 800 by using a Bluetooth as a communications interface.

The frequency control module 22D is signally connected to the conversion module 22B. The frequency control module 22D is adapted to control a frequency of the second alternating-current signal, so that the frequency of the second alternating-current signal can match the low-frequency magnetic signal. In this way, when the second alternating-current signal is converted into a magnetic signal (that is, the low-frequency magnetic signal) again, the low-frequency magnetic signal can be adapted to be provided to a portable electronic device 900 having a wireless charging function (which may be, for example but is not limited to, a mobile device, a notebook computer, a tablet computer, and a digital camera).

The power-transmit communications module 22E is also signally connected to the conversion module 22B, to be adapted to perform handshaking with the portable electronic device 900. The power-transmit communications module 22E of the wireless charging converting apparatus 100 generates a magnetic signal (that is, the low-frequency magnetic signal) after performing handshaking with the portable electronic device 900, and then the low-frequency magnetic signal is received by a wireless charging module of the portable electronic device 900 to charge the portable electronic device 900.

By using the foregoing handshaking procedure, recognition and compatibility detection between the wireless charging station 800, the wireless charging converting apparatus 100, and the portable electronic device 900 can further be implemented, so that the portable electronic device 900 can be effectively charged.

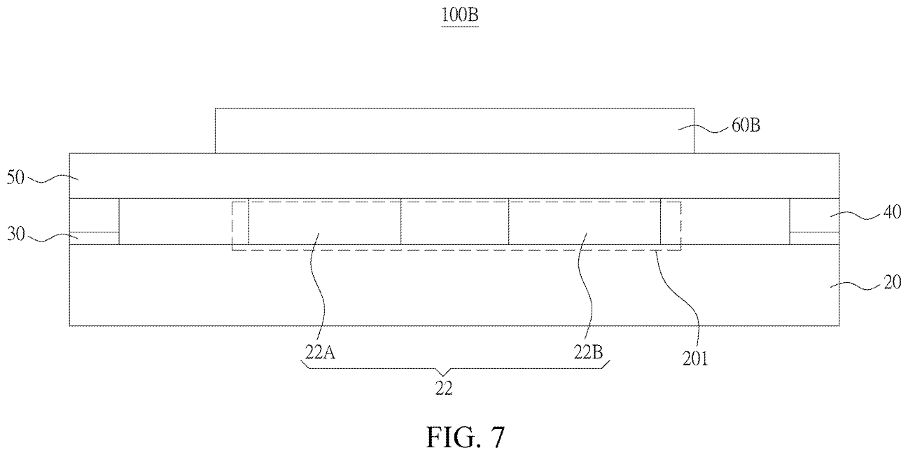

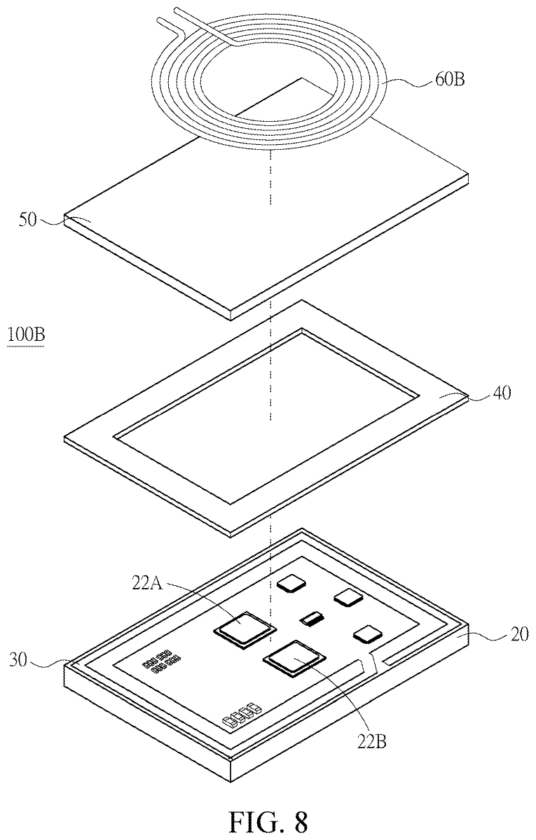

FIG. 7 and FIG. 8 are respectively a schematic sectional view and an exploded view of a third embodiment of a wireless charging converting apparatus 100B according to the present invention. In this embodiment, a transmit coil 60B is a circular, and the diameter of the transmit coil 60B is less than the length and the width of the low-frequency magnetic isolation sheet 50. However, it should be noted that, it is not necessary to limit the sizes of the transmit coil 60B and the low-frequency magnetic isolation sheet 50, provided that the low-frequency magnetic isolation sheet 50 can be shielded between the high-frequency magnetic isolation sheet 40 and the receive coil 30. Therefore, a commercially-available wireless transmit coil that satisfies the Qi standard can also be used as the transmit coil 60B of the wireless charging converting apparatus 100B.

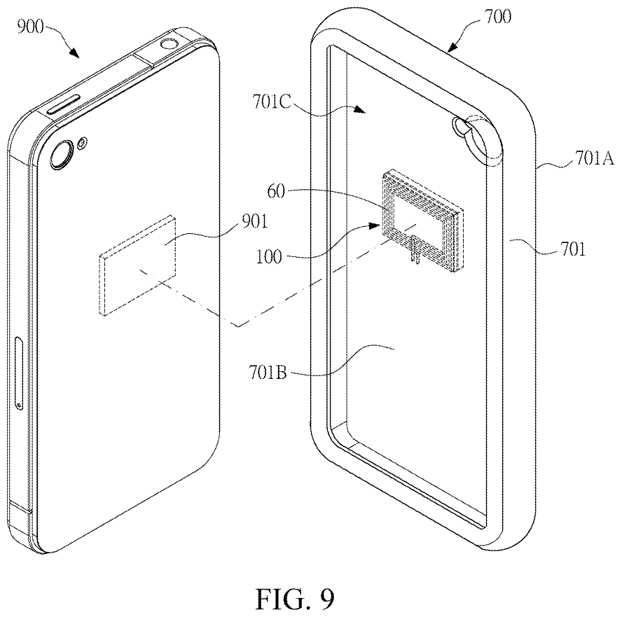

Referring to FIG. 1, FIG. 2, and FIG. 9, FIG. 9 is a schematic diagram of a use status of a protective shell 700 having a wireless charging converting apparatus 100. As shown in FIG. 1, FIG. 2, and FIG. 9, the protective shell 700 includes a housing 701 and the foregoing wireless charging converting apparatus 100.

The housing 701 has an outer surface 701A and an inner surface 701B, and the inner surface 701B includes an accommodation slot 701C that can accommodate a portable electronic device 900. The wireless charging converting apparatus 100 is disposed on the housing 701. For example, a recess can be provided on the housing 701 to accommodate the wireless charging converting apparatus 100, but this is not limited thereto. Alternatively, the wireless charging converting apparatus 100 can be disposed on the housing 701 by using an injection molding process.

In the protective shell 700 of this embodiment, the transmit coil 60 faces the housing 701. Therefore, after the portable electronic device 900 is put into the accommodation slot 701C, the transmit coil 60 can correspond to a wireless charging module 901 of the portable electronic device 900.

In this way, when a wireless charging standard of the portable electronic device 900 is different from the wireless charging standard of the wireless charging station, a user can put the portable electronic device 900 into the protective shell 700, so that the transmit coil 60 of the wireless charging converting apparatus 100 can correspond to the wireless charging module 901 of the portable electronic device 900. Therefore, a magnetic signal that is sent by the wireless charging station can be converted, by using the wireless charging converting apparatus 100 of the protective shell 700, into another magnetic signal that matches the wireless charging module 901 of the portable electronic device 900, thereby implementing wireless charging.

In conclusion, in the one or more embodiments of the present invention, the wireless charging converting apparatus can convert a magnetic signal that satisfies a wireless charging standard into a magnetic signal that satisfies another wireless charging standard. In addition, the high-frequency magnetic isolation sheet and the low-frequency magnetic isolation sheet can effectively prevent the magnetic signal from interfering with the primary circuit or the coil. Furthermore, in the one or more embodiments of the present invention, the user can put the portable electronic device into the protective shell having the wireless charging converting apparatus, so that the magnetic signal that is sent by the wireless charging station can be converted, by using the wireless charging converting apparatus of the protective shell, into another magnetic signal that matches the wireless charging module of the portable electronic device, thereby implementing the wireless charging.

What is claimed is:

1. A wireless charging converting apparatus, comprising:
a circuit board;
a receive coil located on the circuit board, wherein the receive coil is adapted to receive a high-frequency magnetic signal and convert the high-frequency magnetic signal into a first alternating-current signal;
a primary circuit located on the circuit board and adapted to receive the first alternating-current signal and convert the first alternating-current signal into a second alternating-current signal;
a transmit coil adapted to convert the second alternating-current signal into a low-frequency magnetic signal;
a low-frequency magnetic isolation sheet located between the transmit coil and the circuit board; and
a high-frequency magnetic isolation sheet located between the low-frequency magnetic isolation sheet and the receive coil.

2. The wireless charging converting apparatus according to claim 1, wherein the circuit board has a circuit area, the primary circuit is located in the circuit area, and the circuit area is surrounded by the receive coil and the high-frequency magnetic isolation sheet.

3. The wireless charging converting apparatus according to claim 1, wherein the low-frequency magnetic isolation sheet is made of nano-crystal.

4. The wireless charging converting apparatus according to claim 3, wherein the high-frequency magnetic isolation sheet is made of ferrite.

5. The wireless charging converting apparatus according to claim 1, wherein a magnetic permeability of the high-frequency magnetic isolation sheet is between 100 H/m and 700 H/m, and a magnetic permeability of the low-frequency magnetic isolation sheet is between 700 H/m and 1100 H/m.

6. The wireless charging converting apparatus according to claim 1, wherein the primary circuit comprises a rectifier module and a conversion module, the rectifier module is disposed on a side of the circuit board and is electrically connected to the receive coil, the conversion module is disposed on another side of the circuit board and is electrically connected to the transmit coil, the rectifier module is adapted to receive the first alternating-current signal and convert the first alternating-current signal into a direct-current signal, and the conversion module is adapted to convert the direct-current signal into the second alternating-current signal.

7. The wireless charging converting apparatus according to claim 1, wherein a surface of the high-frequency magnetic isolation sheet is essentially flush with a surface of the primary circuit.

8. The wireless charging converting apparatus according to claim 1, wherein the high-frequency magnetic isolation sheet is shielded between the primary circuit and the transmit coil.

9. The wireless charging converting apparatus according to claim 1, wherein a profile of the high-frequency magnetic isolation sheet is inverted U-shaped, the high-frequency magnetic isolation sheet has a groove, and the primary circuit is located in the groove.

10. A protective shell, comprising:
a housing having an inner surface and an outer surface, wherein the inner surface comprises an accommodation slot adapted to accommodate a portable electronic device; and
the wireless charging converting apparatus according to claim 1, disposed in the housing, wherein the transmit coil faces the housing and is adapted to correspond to a wireless charging module of the portable electronic device.

11. A protective shell, comprising:
a housing having an inner surface and an outer surface, wherein the inner surface comprises an accommodation slot adapted to accommodate a portable electronic device; and
the wireless charging converting apparatus according to claim 2, disposed in the housing, wherein the transmit coil faces the housing and is adapted to correspond to a wireless charging module of the portable electronic device.

12. A protective shell, comprising:
a housing having an inner surface and an outer surface, wherein the inner surface comprises an accommodation slot adapted to accommodate a portable electronic device; and
the wireless charging converting apparatus according to claim 3, disposed in the housing, wherein the transmit coil faces the housing and is adapted to correspond to a wireless charging module of the portable electronic device.

13. A protective shell, comprising:
a housing having an inner surface and an outer surface, wherein the inner surface comprises an accommodation slot adapted to accommodate a portable electronic device; and
the wireless charging converting apparatus according to claim 4, disposed in the housing, wherein the transmit coil faces the housing and is adapted to correspond to a wireless charging module of the portable electronic device.

14. A protective shell, comprising:
a housing having an inner surface and an outer surface, wherein the inner surface comprises an accommodation slot adapted to accommodate a portable electronic device; and
the wireless charging converting apparatus according to claim 5, disposed in the housing, wherein the transmit coil faces the housing and is adapted to correspond to a wireless charging module of the portable electronic device.

15. A protective shell, comprising:
a housing having an inner surface and an outer surface, wherein the inner surface comprises an accommodation slot adapted to accommodate a portable electronic device; and
the wireless charging converting apparatus according to claim 6, disposed in the housing, wherein the transmit coil faces the housing and is adapted to correspond to a wireless charging module of the portable electronic device.

16. A protective shell, comprising:
a housing having an inner surface and an outer surface, wherein the inner surface comprises an accommodation slot adapted to accommodate a portable electronic device; and
the wireless charging converting apparatus according to claim 7, disposed in the housing, wherein the transmit coil faces the housing and is adapted to correspond to a wireless charging module of the portable electronic device.

17. A protective shell, comprising:
a housing having an inner surface and an outer surface, wherein the inner surface comprises an accommodation slot adapted to accommodate a portable electronic device; and
the wireless charging converting apparatus according to claim 8, disposed in the housing, wherein the transmit coil faces the housing and is adapted to correspond to a wireless charging module of the portable electronic device.

18. A protective shell, comprising:
a housing having an inner surface and an outer surface, wherein the inner surface comprises an accommodation slot adapted to accommodate a portable electronic device; and
the wireless charging converting apparatus according to claim 9, disposed in the housing, wherein the transmit coil faces the housing and is adapted to correspond to a wireless charging module of the portable electronic device.
